(19) United States
(12) Patent Application Publication
(10) Pub. No.: US 2022/0206164 A1
(43) Pub. Date: Jun. 30, 2022

(54) OPTICAL INTERFERENCE MEASUREMENT DEVICE

(71) Applicant: Topcon Corporation, Tokyo (JP)

(72) Inventor: Akira TAKADA, Tokyo (JP)

(73) Assignee: Topcon Corporation, Tokyo (JP)

(21) Appl. No.: 17/645,045

(22) Filed: Dec. 18, 2021

(30) Foreign Application Priority Data
Dec. 24, 2020 (JP) 2020-215734

(51) Int. Cl. G01S 17/931; G01S 7/4911

(52) U.S. Cl. CPC G01S 17/931; G01S 7/4911

(57) ABSTRACT

An optical interference measurement device includes: a light source having a wavelength-swept light source that changes a wavelength of emitted light periodically; a light splitter configured to split light emitted from the light source into measurement light and reference light; a measurement section configured to emit the measurement light onto a measurement target; an interference section configured to couple the measurement light reflected or scattered by the measurement target and the reference light together to produce interfering light; a light detector configured to detect the interfering light; and an analyzer configured to analyze an interference signal detected by the light detector. The optical interference measurement device has an optical element in the measurement section, and the optical element is configured to cause an optical loss that makes an amount of light received inversely proportional to a square of a propagation distance.

### BACKGROUND

The present disclosure relates to an optical interference measurement device.

In recent years, there have been significant technical developments for achieving autonomous vehicle driving. Among the techniques, obstacle detection using images, millimeter-wave radars, or Light Detection and Rangings (LiDARs) are focused on. LiDARs need to have distance and angle measurement functions. As distance measurement methods, ToF systems using a pulsed light source and frequency modulated continuous wave (FMCW) systems using a modulated continuous wave have been competing with each other.

For example, Japanese Unexamined Patent Publication No. 2019-095218 discloses a distance measurement sensor using an FMCW-LiDAR.

### SUMMARY

Since FMCW is interference measurement, a signal-to-noise ratio (SNR) is expected to improve, but phase noise needs to be considered.

It is therefore an object of the present disclosure to provide an optical interference measurement device that can be used as an FMCW-LiDAR and has an improved signal-to-noise ratio by reducing the influence of phase noise.

To achieve the above object, an optical interference measurement device according to an embodiment of the present disclosure includes: a light source having a wavelength-swept light source that changes a wavelength of emitted light periodically; a light splitter configured to split light emitted from the light source into measurement light and reference light; a measurement section configured to emit the measurement light onto a measurement target; an interference section configured to couple the measurement light reflected or scattered by the measurement target and the reference light together to produce interfering light; a light detector configured to detect the interfering light; and an analyzer configured to analyze an interference signal detected by the light detector, wherein the optical interference measurement device has an optical element in the measurement section, the optical element being configured to cause an optical loss that makes an amount of light received inversely proportional to a square of a propagation distance.

According to the present disclosure, it is possible to make the noise floor constant by reducing the influence of phase noise and provide an optical interference measurement device with an improved signal-to-noise ratio.

### BRIEF DESCRIPTION OF THE DRAWINGS

FIG. 1 is a diagram illustrating a schematic configuration of an optical interference measurement device according to an embodiment of the present disclosure.

FIG. 2 is a diagram showing a calculation result of a distance-measuring FMCW before measures against phase noise are taken.

FIG. 3 is a diagram showing the intensity of noise at its peak position for each of the measurement distances in FIG. 2.

FIG. 4 is a diagram showing an optical loss for optimization of a light-receiving optical system.

FIG. 5 is a diagram showing a calculation result of a distance-measuring FMCW after an improvement in phase noise.

FIG. 6 is a diagram illustrating an example of an optical element.

FIG. 7 is a diagram illustrating an example of an optical element.

### DETAILED DESCRIPTION

Now, an optical interference measurement device according to an embodiment of the present disclosure will be described with reference to the drawings. The optical interference measurement device 1 is an optical frequency-modulated continuous-wave heterodyne interferometer which couples measurement light and reference light together to produce interfering light and can measure a distance and other parameters using a beat frequency.

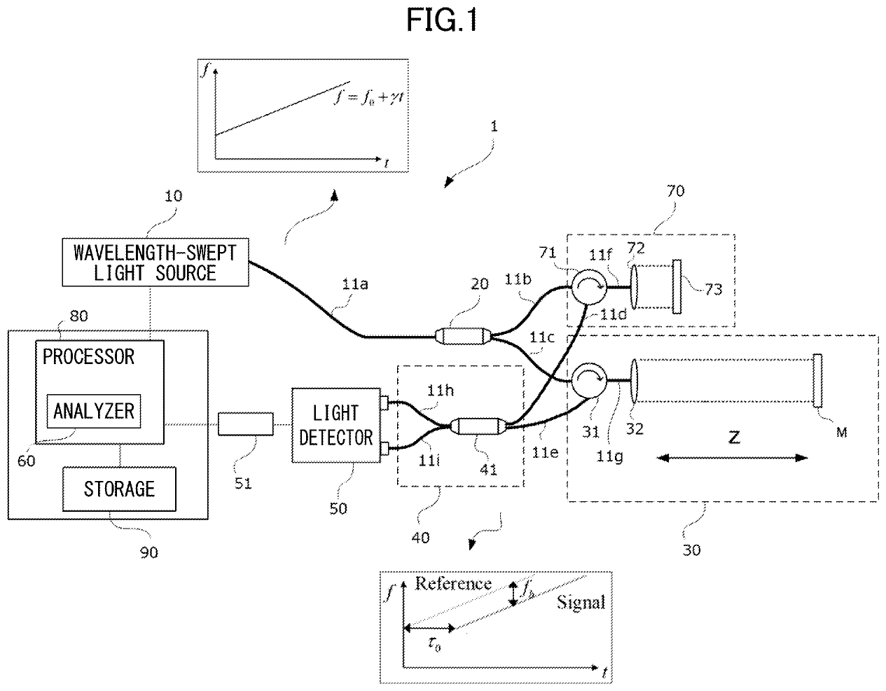

FIG. 1 is a diagram illustrating a schematic configuration of an optical interference measurement device according to an embodiment of the present disclosure. The optical interference measurement device 1 includes a light source 10, a light splitter 20, a reference section 70, a measurement section 30, an interference section 40, a light detector 50, and an analyzer 60.

The light source 10 is a wavelength-swept light source in which a frequency (wavelength) of light is changed periodically in a predetermined sweep frequency band ΔF and in a cycle period T, and linearly at a constant amount of change, using a coherent continuous wave light source. As illustrated in FIG. 1, the frequency (wavelength) changes with time at a predetermined chirp rate y from the frequency f₀ at the start of sweep.

The light to be swept is preferably such light whose center wavelength, i.e., the sweep center wavelength, is included in an eye safety region (light in this region is safe for human eyes), specifically a near infrared region, e.g., 1550 nm band, for autonomous driving of vehicles.

The coherence length of the light emitted from the light source is preferably at least 50 meters or longer in order that a vehicle can detect obstacles.

The light emitted from the light source 10 employing such a wavelength-swept light source transmits through an optical guide path 11a comprised of an optical fiber or the like, and reaches the light splitter 20.

The light splitter 20 splits the light emitted from the light source 10 into measurement light and reference light. The light splitter 20 is, for example, a 1×2 optical coupler for splitting an optical path. The light split by the light splitter 20 transmits to the reference section 70 through an optical guide path 11b and to the measurement section 30 through an optical guide path 11c separately.

The reference section 70 is a system that functions as a reference for light in the measurement section 30. The light to transfer through the reference section 70 passes through an optical circulator 71 and is emitted through an optical guide path 11f. The light is then shaped into parallel light by an optical element 72, such as a collimating lens, and is reflected on a reference mirror 73 having a metallic mirror surface, for example. The reference light reflected (return light of the reference light) passes through the optical element 72, which also functions as a light receiving system of the reference section 70, passes through an optical guide path 11d, and is guided to the interference section 40.

The measurement section 30 emits the measurement light onto a measurement target M. The light to transfer through the measurement section 30 passes through an optical circulator 31 and is emitted through an optical guide path 11g. The light is then shaped into parallel light by an optical element 32, such as a collimating lens, and is emitted onto the measurement target M. The measurement target M is, for example, an object around a vehicle that is traveling or stopped. The return light from the measurement target M (light including light reflected by the measurement target M and light scattered by the measurement target M) passes through the optical element 32, which also functions as a light receiving system of the measurement section 30, passes through an optical guide path 11e, and is guided to the interference section 40.

A measurement distance z in the measurement section 30 is merely an example of a distance for reference. Several meters to several hundred meters are assumed as a distance for autonomous driving of vehicles. Thus, the coherence length of the light emitted from the light source 10 is preferably a certain length or longer, e.g., at least 50 meters or longer.

The interference section 40 is a system that couples the measurement light reflected or scattered by the measurement target M and the reference light together to produce interfering light. Optical paths of the return light from the measurement section 30 and the return light from the reference section 70 are combined together by a light combiner 41, which is, for example, a 2×2 optical coupler for splitting an optical path, and interfere with each other, resulting in formation of interfering light. The interfering light is guided to the light detector 50 through optical guide paths 11h and 11i.

The measurement section 30, the reference section 70, and the interference section 40 may be any elements that have functions equivalent to the functions of the respective sections. The optical paths are not limited to those described in this example, and appropriate optical paths may be set freely. For example, optical paths may be designed freely using a beam splitter and/or a half mirror, and optical elements having the function of selecting a wavelength and/or adjusting a polarization state may be disposed in the optical paths.

The light detector 50 is for detecting interfering light, and may be, for example, a balanced photodetector (BPD) that uses photoelectric conversion elements, such as two photodiodes, and outputs a differential. The light detector 50 outputs an interference signal. The interference signal is input to the analyzer 60 through a filter 51.

The filter 51 is not an optical filter that selects wavelengths, but an electric filter that detects interfering light as an interference signal and then extracts predetermined frequency components from the interference signal.

As illustrated in FIG. 1, the time at which the measurement light (Signal) reaches the light combiner 41 and the time at which the reference light (Reference) reaches the light combiner 41 are shifted by to due to the optical path difference, and the frequency difference appears as a beat frequency fb.

The interference signal is subjected to an FFT analysis in the analyzer 60 and is output as a calculation result of the distance-measuring FMCW. The analyzer 60 calculates the measurement distance using the beat frequency generated by the delay time resulting from the optical path difference between the reference section 70 and the measurement section 30. If the peak value of the spectrum obtained by the analysis is greater than or equal to a predetermined signal-to-noise ratio, the distance can be measured.

The interference signal may be sampled at a predetermined sampling rate and stored in a storage 90. The analyzer 60 may also be program software that is stored in the storage 90 and performs the analysis function by being executed by a processor 80.

The processor 80 executes the functions and/or methods implemented by codes or commands included in the programs stored in the storage 90. Examples of the processor 80 include a central processing unit (CPU), a microprocessor unit (MPU), a graphics processing unit (GPU), a microprocessor, a processor core, a multiprocessor, an application specific integrated circuit (ASIC), and a field-programmable gate array (FPGA). The processor 80 may include a logic circuit or a dedicated circuit formed in an integrated circuit, for example, to execute the processing disclosed in the embodiment. These circuits may be implemented as one or more integrated circuits. A single integrated circuit may execute the plural types of processing described in the embodiment.

The storage 90 has the function of storing various programs or various data that are needed. The storage 90 can store acquired information, such as signals measured. The storage 90 is implemented as various storage media, such as a hard disk drive (HDD), a solid state drive (SSD), and a flash memory.

A measurement using FMCW requires highly coherent light source having a narrow linewidth in order to achieve a long-distance interference measurement. The signal-to-noise ratio in the interference measurement is determined based on various factors, such as the amount of light received, the amount of reference light, shot noise, intensity noise, and phase noise. However, so far, little consideration has been given to phase noise. Generally, in coherence detection, the signal-to-noise ratio is determined mainly by the shot noise, but in a measurement of a distance equivalent to a coherence length, the signal-to-noise ratio is determined rather by the phase noise. The phase noise does not depend on the amount of light received nor on the amount of reference light. Thus, the signal-to-noise ratio determined by the phase noise is not affected by the amount of light received nor the amount of reference light, and is not affected even if the light amount of the light source is increased in an attempt to increase the light amount of the signals.

For example, the measurement distance is long in the case of a distance measurement for autonomous driving of vehicles. In the case of the coherence length of 100 meters, for example, the linewidth for reference is preferably 0.95 MHz as a requirement for the light source for distance-measuring FMCW.

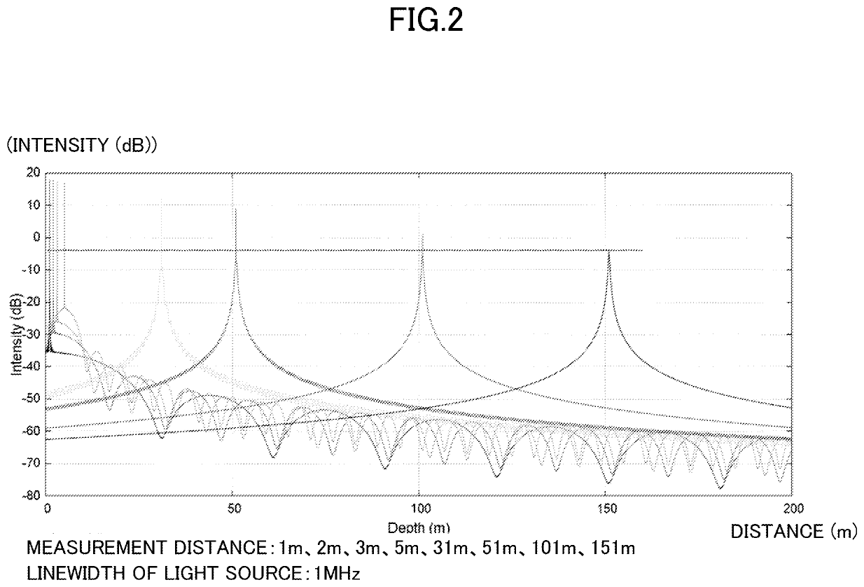

Even if such a light source is available, the longer distance to be measured causes higher noise floor. FIG. 2 is a diagram showing a calculation result of an FFT-analyzed distance-measuring FMCW representing an increase in the noise floor before measures against phase noise are taken. The vertical axis represents the signal intensity (dB), and the horizontal axis represents the distance (m). The linewidth of the light source is 1 MHz. The diagram shows the signal intensity at measurement distances of 1 m, 2 m, 3 m, 5 m, 31 m, 51 m, 101 m, and 151 m, and shows that the noise floor is higher with an increase in the measurement distance. For example, at the distance of 151 m, no signal is output, but noise similar to signals is generated. A horizontal dotted line is drawn at the position where the intensity of this noise peaks.

The higher noise floor resulting from an increase in the measurement distance restricts the dynamic range of the measurement. It is assumed that such noise is generated because a low-frequency component (short-distance component) of reflected light generated outside a measurement range cannot be cut by a filter and is observed as higher noise floor.

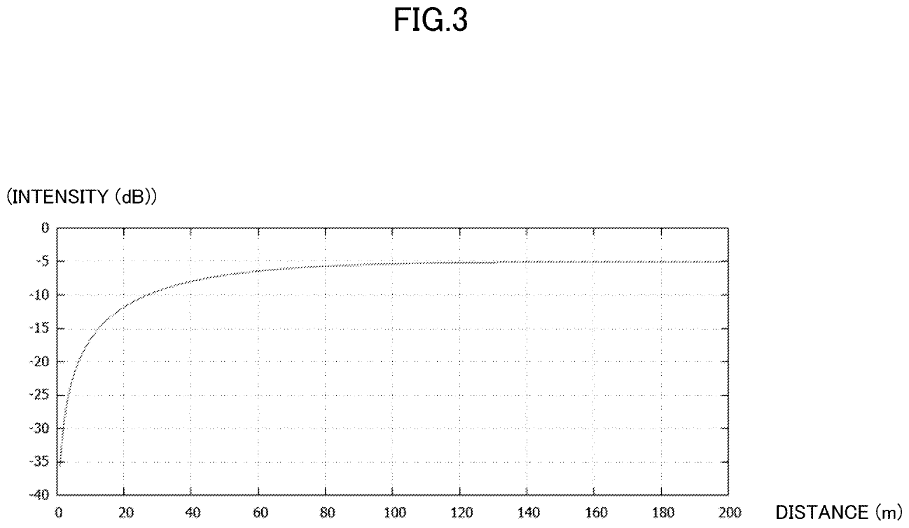

FIG. 3 is a diagram showing the intensity of noise at its peak position generated at each of the measurement distances in FIG. 2 and plotted with the horizontal axis as the measurement distance. For example, at the measurement distance of 30 m, a signal of about 10 dB is output in FIG. 2, but the peak position of the noise floor is located at about −10 dB. This position is plotted as the noise peak. This phenomenon can be roughly understood from FIG. 2, but FIG. 3 shows it in an easy-to-understand manner. The intensity of the noise floor peak affected by the phase noise increases with an increase in the distance, like a hyperbola with the X axis serving as an asymptote. Hence, it is effective to take measures to cancel and reduce the influence of the phase noise that depends on the distance.

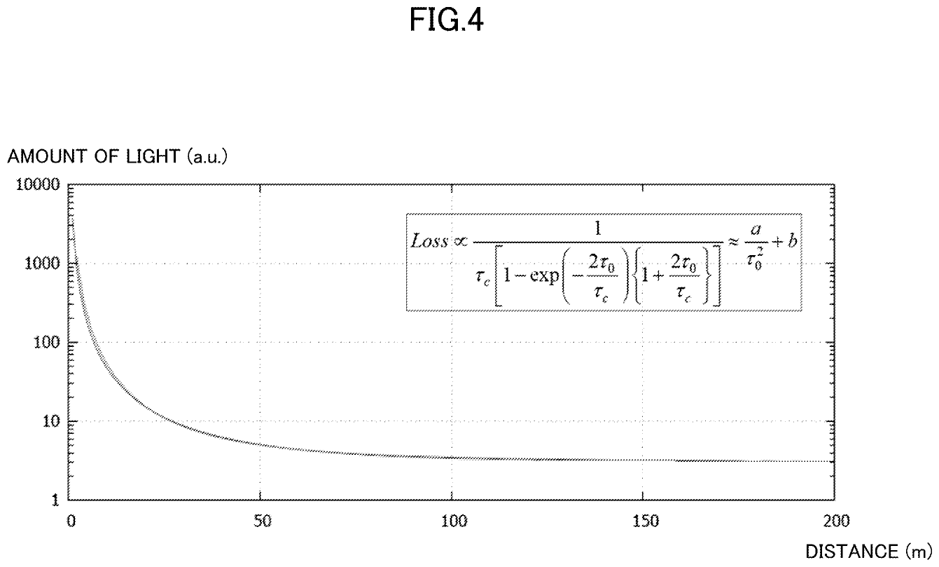

FIG. 4 is a diagram showing an optical loss for optimization of a light-receiving optical system according to the present disclosure. Although signal processing is a technique for dealing with the phase noise that increases with an increase in the distance, in the present disclosure, the noise floor is made constant through optimization of the light receiving efficiency of the measurement section. The optical loss shown in FIG. 4 is represented approximately by a/τ₀+b, where a and b are constants. That is, the amount of light received is inversely proportional to the delay time τ₀′, i.e., the square of the measurement distance. If such an optical loss can be given, the noise floor can be lowered to a certain level. Specifically, this can be realized by using a light projection system in which the light projection area increases in proportion to the square of the distance.

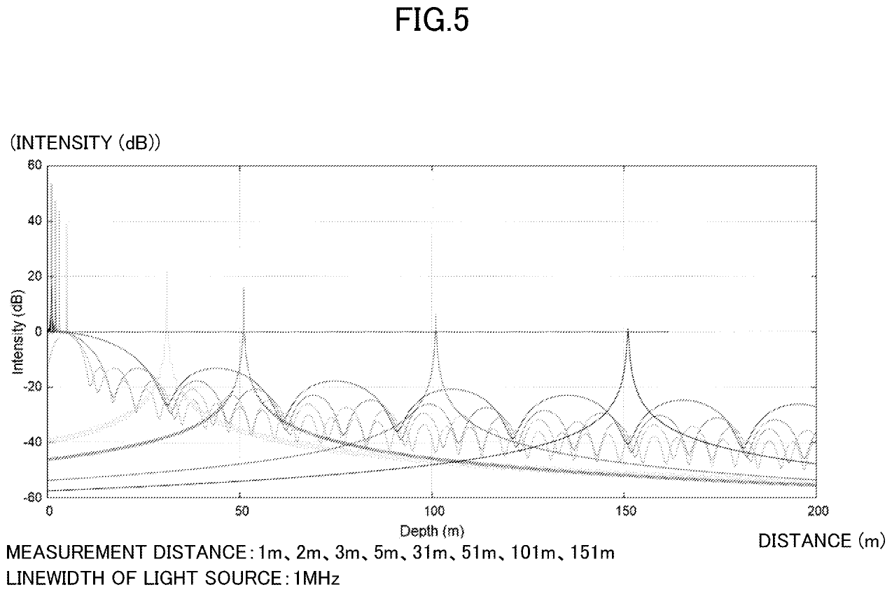

FIG. 5 is a diagram showing a calculation result of an FFT-analyzed distance-measuring FMCW according to the present disclosure after the optical loss shown in FIG. 4 is given to optimize the light receiving system. Similarly to FIG. 2, the vertical axis represents the signal intensity (dB), and the horizontal axis represents the distance (m). The linewidth of the light source is 1 MHz. The diagram shows the signal intensity at measurement distances of 1 m, 2 m, 3 m, 5 m, 31 m, 51 m, 101 m, and 151 m. The diagram shows that the optimization of the light receiving system improves the signal-to-noise ratio. For example, the measurement distance of 51 meters is generally about the coherence length while taking the round trip of the measurement light into consideration. Regarding this distance, the signal intensity improves from a little less than 10 dB before improvements in FIG. 2 to a little less than 20 dB in the embodiment of the present disclosure in FIG. 5. Regarding the measurement distance of 31 meters, as well, the signal intensity improves and exceeds 20 dB.

Accordingly, a predetermined loss may be given to the light receiving system of the measurement system. More specifically, the amount of light received may be inversely proportional to the square of the propagation distance z. Light is attenuated in inverse proportion to the square of the distance due to an inverse square law. However, the optical loss according to the present embodiment is not caused by the natural law, but is caused by a specific optical element intentionally arranged in the optical system. Such an optical element can be implemented by various types of optical elements, and an example thereof will be described below.

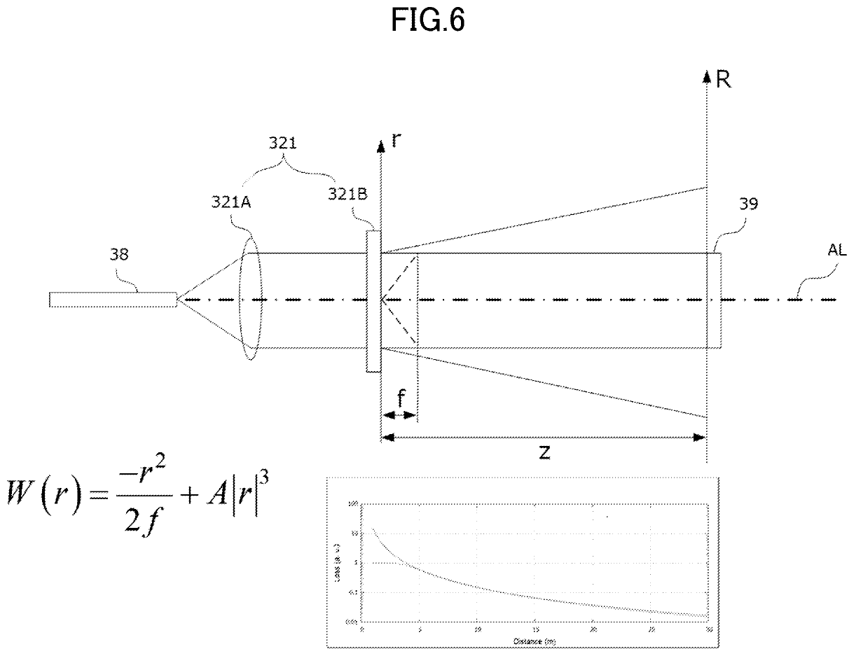

FIG. 6 shows an example of an optical element in which the amount of light received is inversely proportional to the square of the propagation distance z. In this system, an optical element 321 is disposed with respect to an optical axis AL of light projected from a light projecting section 38 which is a light irradiation port of an optical path, such as an optical fiber. The optical element 321 is, for example, an optical element that changes a wavefront and is comprised of a refractive optical element 321A, such as an aspherical lens, and a diffractive optical element 321B.

According to the optical element of this example, light projected from the light projecting section 38 is converted into parallel light by the refractive optical element 321A, and a wavefront represented by W(r)=−r²/2f+A|r|³ is formed after going through the diffractive optical element 321B, where f is a distance at which the measurement starts, and A is a constant satisfying 0<A<1. Thus, the amount of light received is inversely proportional to the square of the propagation distance z at a distance where the measurement distance z>f is satisfied. For example, as shown in FIG. 6, when the distance f is equal to 5 meters (f=5 m) or longer, the decrease in the amount of light substantially coincides with a curve that is inversely proportional to the square of z. Using such an optical element 321, which is an example, makes it possible to give the optical loss that makes the amount of light received inversely proportional to the square of the propagation distance z. As a result, the intensity of the noise floor peak affected by the phase noise is made constant, making it possible to improve the signal-to-noise ratio.

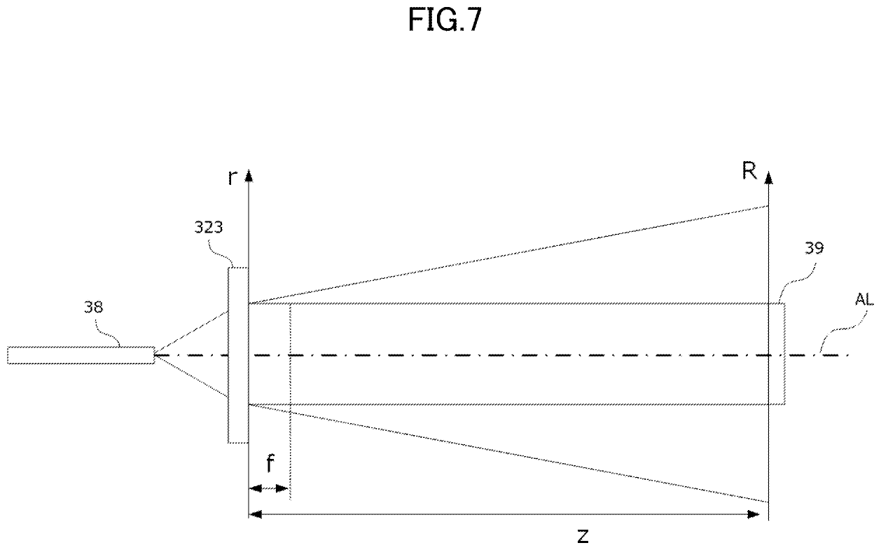

FIG. 7 shows an example of another optical element. In this system, an optical element 323 is disposed with respect to an optical axis AL of light projected from the light projecting section 38 which is a light irradiation port of an optical path, such as an optical fiber. For example, an optical element 321, which is a refractive optical element such as a lens, or a diffractive optical element may be used as the optical element 323. The optical element 323 may be comprised of at least one optical element configured, through appropriate optical design, to give optical loss that makes the amount of light received inversely proportional to the square of the propagation distance z.

These optical elements may be disposed, for example, in the light projection system of the measurement section 30. If the measurement section 30 has a light projection system and a light receiving system, the light receiving system may have such characteristics for the light returned by reflection or diffusion. If the light projection system and the light receiving system also have the function of each other, the light projection system and the light receiving system together may have such characteristics. The position where the optical element is to be disposed and the specific design can be appropriately selected by those skilled in the art.

As in the foregoing description, the optical interference measurement device 1 according to an embodiment of the present disclosure includes: a light source 10 having a wavelength-swept light source that changes a wavelength of light periodically; a light splitter 20 configured to split light emitted from the light source 10 into measurement light and reference light; a measurement section 30 configured to emit the measurement light onto a measurement target; an interference section 40 configured to couple the measurement light reflected or scattered by the measurement target and the reference light together to produce interfering light; a light detector 50 configured to detect the interfering light; and an analyzer 60 configured to analyze an interference signal detected by the light detector 50, wherein the optical interference measurement device has an optical element 321 in the measurement section, the optical element 321 being configured to cause an optical loss that makes an amount of light received inversely proportional to a square of a propagation distance. This configuration makes it possible to make the noise floor of the phase noise, which increases with an increase in the measurement distance, constant and reduce the influence of the phase noise. The signal-to-noise ratio of an optical interference measurement device employing FMCW systems can thus improve.

The characteristics of the above-described optical element 321 can be acquired through various types of optical elements or a combination of such optical elements. The above effects can be obtained by using an optical element that changes a wavefront and is comprised of a refractive optical element 321A, which is, for example, an aspherical lens, and a diffractive optical element 321B.

The embodiments of the present disclosure have been described above, but the aspects of the present disclosure are not limited to these embodiments.

What is claimed is:

1. An optical interference measurement device, comprising:
a light source having a wavelength-swept light source that changes a wavelength of emitted light periodically;
a light splitter configured to split light emitted from the light source into measurement light and reference light;
a measurement section configured to emit the measurement light onto a measurement target;
an interference section configured to couple the measurement light reflected or scattered by the measurement target and the reference light together to produce interfering light;
a light detector configured to detect the interfering light; and
an analyzer configured to analyze an interference signal detected by the light detector, wherein
the optical interference measurement device has an optical element in the measurement section, the optical element being configured to cause an optical loss that makes an amount of light received inversely proportional to a square of a propagation distance.

2. The optical interference measurement device of claim 1, wherein
the optical element is comprised of at least one diffractive optical element and at least one refractive optical element.

3. The optical interference measurement device of claim 2, wherein
the refractive optical element is an aspherical lens, and
the optical element is an optical element that changes a wavefront and is configured as a combination of the diffractive optical element and the refractive optical element.

4. The optical interference measurement device of claim 1, wherein
the optical element is comprised of at least one diffractive optical element.

5. The optical interference measurement device of claim 1, wherein
the optical element is comprised of at least one refractive optical element.

6. The optical interference measurement device of claim 1, wherein
light emitted from the wavelength-swept light source has a sweep center wavelength included in a near infrared region and a coherence length of 50 meters or longer.
